(19) United States
(12) Patent Application Publication
(10) Pub. No.: US 2026/0080284 A1
(43) Pub. Date: Mar. 19, 2026

(54) METHOD FOR DETERMINING AN UNCERTAINTY ASSOCIATED WITH TRAJECTORY PREDICTIONS OF A VEHICLE

(71) Applicant: Robert Bosch GmbH, Stuttgart (DE)

(72) Inventors: Aron Distelzweig, Schwanau (DE); Andreas Look, Wiesengiech (DE); Eitan Kosman, Haifa (IL)

(21) Appl. No.: 19/291,841

(22) Filed: Aug. 6, 2025

(30) Foreign Application Priority Data
Sep. 18, 2024 (DE) 10 2024 208 911.7

(51) Int. Cl. G06N 7/01

(52) U.S. Cl. CPC G06N 7/01

(57) ABSTRACT

A method for determining an uncertainty associated with trajectory predictions of a vehicle. The method includes providing a trained machine learning model, the machine learning model being trained to predict trajectories based on sensor data and to assign scores reflecting a likelihood of each predicted trajectory; providing predicted trajectory distributions using respective predictions based on the sensor data by the at least one trained machine learning model; utilizing Monte Carlo sampling to estimate an entropy of a respective predicted trajectory distribution, thereby obtaining an estimate of an aleatoric uncertainty; utilizing Monte Carlo sampling to estimate an entropy of the predicted trajectory distributions, thereby obtaining an estimate of a total uncertainty; determining an epistemic uncertainty by subtracting the aleatoric uncertainty from the total uncertainty; providing the determined epistemic uncertainty and the aleatoric uncertainty for the predicted trajectories of the at least one machine learning model.

### CROSS REFERENCE

The present application claims the benefit under 35 U.S.C. § 119 of Germany Patent Application No. DE 10 2024 208 911.7 filed on Sep. 18, 2024, which is expressly incorporated herein by reference in its entirety.

### FIELD

The present invention relates to a method for determining an uncertainty associated with trajectory predictions of a vehicle. Furthermore, the present invention relates to a computer program, an apparatus, and a storage medium for this purpose.

### SUMMARY

Trajectory prediction is essential for planning the actions of automated vehicles. However, to accurately assess the risks of planned manoeuvres, the predicted paths must include information about their uncertainty. In essence, it is crucial to know whether the model predicting the paths may be trusted.

This has not been a significant focus within the autonomous driving domain until recently. Only a few studies have tried to provide reliable estimates of how much the predictions of a trajectory prediction model can be trusted. For example, the observation may be utilized that models that produce trajectories as heatmaps provide a natural intrinsic uncertainty estimator in the spread of their output. Furthermore, a neural network may be trained to estimate the trajectory prediction error in a supervised manner. During inference, the estimated prediction error may be used as the uncertainty.

### SUMMARY

According to certain aspects of the present invention, a method, a computer program, a data processing apparatus, and as a computer-readable storage medium are provided. Features and details of the present invention are disclosed herein. Features and details described in the context to the method of the present invention also correspond to the computer program of the present invention, the data processing apparatus of the present invention, as well as the computer-readable storage medium of the present invention, and vice versa in each case.

According to an aspect of the present invention, a method for determining an uncertainty associated with trajectory predictions of a vehicle is provided. According to an example embodiment of the present invention, the comprises:
Providing at least one trained machine learning model, the at least one machine learning model being trained to predict trajectories based on sensor data and to assign scores reflecting a likelihood of each predicted trajectory,
Providing at least two predicted trajectory distributions by means of respective predictions based on the sensor data by the at least one trained machine learning model,
Utilizing Monte Carlo sampling to estimate an entropy of a respective predicted trajectory distribution, thereby obtaining an estimate of an aleatoric uncertainty,
Utilizing Monte Carlo sampling to estimate an entropy of the at least two predicted trajectory distributions, thereby obtaining an estimate of a total uncertainty,
Determining an epistemic uncertainty by subtracting the aleatoric uncertainty from the total uncertainty,
Providing the determined epistemic uncertainty and the aleatoric uncertainty for the predicted trajectories of the at least one machine learning model.

According to an example embodiment of the present invention, by means of the at least one machine learning model, an ensemble may be created that includes the at least two predicted trajectory distributions by training the machine learning model at least twice. Alternatively, methods like variational inference or Laplace Approximation may be used. In a further alternative, at least two differently trained machine learning models may be provided to respectively provide a predicted trajectory distribution. The sensor data may comprise image, radar, lidar and/or ultrasound data and may be or have been acquired in a traffic environment. The likelihood may represent a probability for the respective trajectory to be followed by a vehicle based on the sensor data. The at least one machine learning model may for example be LaPred (Kim et al., “LaPred: Lane-Aware Prediction of Multi-Modal Future Trajectories of Dynamic Agents”), LaFormer (Liu et al., “LAformer: Trajectory Prediction for Autonomous Driving with Lane-Aware Scene Constraints”), and PGP (Deo et al., “Multimodal Trajectory Prediction Conditioned on Lane-Graph Traversals”). This list shows only examples and may be extended as needed. Monte Carlo sampling is particularly a computational technique that uses random sampling to obtain numerical solutions to problems that are too complex to solve analytically. It may involve generating a large number of random samples and using statistical methods to estimate the behaviour of a system or process.

Mutual information is particularly a measure of an amount of information that one random variable contains about another. In the present context, the mutual information between the machine learning model's predictions and its parameters may provide insights into how much the parameters influence the predictions.

It may be possible to distinguish between uncertainties arising from model limitations (epistemic) and those stemming from inherent randomness in data (aleatoric). This decomposition may allow for a more nuanced understanding of prediction errors, enabling targeted improvements to both the machine learning model and the data acquisition process. Particularly by leveraging multiple models with diverse training methodologies, the method according to the present invention may enhance a robustness and accuracy of uncertainty quantification without requiring additional learning phases or complex approximators. The resulting epistemic and aleatoric uncertainties may provide valuable insights for safety-critical applications like autonomous driving, allowing systems to make more informed decisions in complex scenarios.

According to an example embodiment of the present invention, utilizing the Monte Carlo sampling may comprise:
Fitting a Gaussian Mixture Model to final positions of respective predicted trajectories in the at least two predicted trajectory distributions,
Sampling from a fitted Gaussian Mixture Model of a respective predicted trajectory distribution to provide samples for estimating the aleatoric uncertainty or sampling from all fitted Gaussian Mixture Models to provide samples for estimating the total uncertainty.

A Gaussian Mixture Model is particularly a probabilistic model that represents a probability distribution as a weighted sum of Gaussian distributions. It may be used for clustering and density estimation.

It is further possible that the epistemic uncertainty reflects an uncertainty due to limitations in the respective machine learning model's training or training data. The aleatoric uncertainty may represent an inherent randomness that the respective machine learning model cannot capture. The epistemic uncertainty may thus reflect variances arising from factors such as the quality, quantity, or representativeness of the training data used for the machine learning model. Additionally, limitations in the chosen model architecture or training algorithms may contribute to epistemic uncertainty. Conversely, aleatoric uncertainty may capture inherent randomness present in the real world that even sophisticated machine learning models cannot fully predict or model. Examples include unpredictable human behaviour or external disturbances that are not captured in the training data.

According to an example embodiment of the present invention, it is possible that the method further comprises:
Selecting trajectories of the set of predicted trajectories that have an epistemic uncertainty above a defined threshold,
Providing the selected trajectories as training data for training a machine learning model based on the selected trajectories.

This may enhance an accuracy and robustness of future trajectory predictions by the machine learning model trained with the selected trajectories. Selecting trajectories with high epistemic uncertainty may identify those predictions where the machine learning model is less confident, highlighting areas that may be particularly relevant for further training. Training a machine learning model on these specific trajectories may allow to focus on refining its understanding of complex or uncertain situations, leading to more accurate and reliable predictions overall.

According to an example embodiment of the present invention, it is further possible that a training of the at least one trained machine learning model comprises:
Providing training data, the training data comprising sensor data captured by at least one sensor and ground truth data, the ground truth data depicting trajectories that are represented in the sensor data,
Extracting features from the sensor data, the extracted features comprising positions, velocities and/or objects in the sensor data, the extracted features being represented in a sequential format,
Training the at least one machine learning model based on the training data and/or the extracted features, wherein a loss function is minimized that represents a difference between trajectories predicted by the at least one machine learning model and corresponding trajectories of the ground truth data, wherein scores are assigned to each predicted trajectory reflecting the likelihood of the respective trajectory.

According to an example embodiment of the present invention, the sensor data may comprise image, radar, lidar and/or ultrasound data and may be or have been acquired in a traffic environment. The sensor may accordingly be a camera, radar, lidar and/or ultrasound sensor. The extracted features from the sensor data may include positional information, velocities of objects within the sensor's field of view, and object detection results. These features may be organized in a sequential format to reflect the temporal nature of the data. The machine learning model may be trained using this structured data, minimizing a loss function that quantifies the discrepancy between predicted trajectories and the ground truth trajectories. During training, the at least one machine learning model may assign scores to its generated predictions, indicating the likelihood of each trajectory being accurate.

According to an example embodiment of the present invention, it is possible that at least two differently trained machine learning models are provided and the method further comprises:
Determining a correlation between the uncertainties and an average of pointwise distances between a respective predicted trajectory and a corresponding trajectory of the ground truth data for at least two combinations of the at least two trained machine learning models.

It may thereby be possible to analyze the correlation between uncertainty measures and prediction accuracy. By examining the relationship between uncertainties (epistemic and aleatoric uncertainties) and the average pointwise distances between predicted and ground truth trajectories, more insights may be gained into how well the machine learning models capture the true trajectory. A negative correlation may indicate that machine learning models with higher uncertainties tend to produce less accurate predictions, highlighting areas for improvement. Conversely, a weak or no correlation may suggest that uncertainty measures are not directly indicative of prediction accuracy in this specific context. Further analysis may involve visualizing the relationship between these uncertainties, potentially revealing patterns or trends. This step may allow for a deeper understanding of the machine learning models' performance in conjunction with the uncertainty estimates.

According to an example embodiment of the present invention, it is further possible that the method further comprises:
Initiating a safety measure in the vehicle based on a result of the estimate of the total uncertainty, the safety measure comprising an output of a warning and/or a manoeuvring of the vehicle according to a defined safety manoeuvre.

For instance, if a high level of uncertainty is identified, an audible or visual warning may be put out, prompting a driver to take evasive action. Alternatively, the vehicle may automatically adjust its speed or trajectory to minimize potential risks associated with the uncertain predictions. The safety manoeuvre may thus at least comprise an adjustment of speed of the vehicle.

According to an example embodiment of the present invention, it is possible that the method further comprises:
Selecting a trajectory with a minimal associated uncertainty,
Initiating a manoeuvring of the vehicle along the selected trajectory.

This selection process may thus prioritize trajectories associated with lower overall uncertainty, indicating a higher degree of confidence in their accuracy. By initiating a manoeuvre along the chosen trajectory, the vehicle may operate with increased safety and reliability, as it may follow a path deemed more predictable and less susceptible to unforeseen variations. This approach may enhance a decision-making by leveraging the quantitative uncertainty measures to guide vehicle actions.

It is possible that the method according to the present invention is used in a vehicle. The vehicle may, for example, be designed as a passenger vehicle and/or autonomous vehicle. The vehicle may have a vehicle device for providing an autonomous driving function and/or a driver assistance system. The vehicle device may be designed to at least partially automatically steer and/or accelerate and/or brake and/or steer the vehicle.

In another aspect of the present invention, a computer program may be provided, in particular a computer program product, comprising instructions which, when the computer program is executed by a computer, cause the computer to carry out the method according to the present invention. Thus, the computer program according to the present invention can have the same advantages as have been described in detail with reference to a method according to the present invention.

In another aspect of the present invention, an apparatus for data processing may be provided, which is configured to execute the method according to the present invention. As the apparatus, for example, a computer can be provided which executes the computer program according to the present invention. The computer may include at least one processor that can be used to execute the computer program. Also, a non-volatile data memory may be provided in which the computer program may be stored and from which the computer program may be read by the processor for being carried out.

According to another aspect of the present invention a computer-readable storage medium may be provided which comprises the computer program according to the present invention and/or instructions which, when executed by a computer, cause the computer to carry out the steps of the method according to the present invention. The storage medium may be formed as a data storage device such as a hard disk and/or a non-volatile memory and/or a memory card and/or a solid state drive. The storage medium may, for example, be integrated into the computer.

Furthermore, the method according to the present invention may be implemented as a computer-implemented method. Alternatively or additionally, at least one of the disclosed method steps may be computer-implemented and/or automated.

Further advantages, features and details of the present invention will be apparent from the following description, in which embodiments of the present invention are described in detail with reference to the figures. In this context, the features mentioned herein may each be essential to the present invention individually or in any combination.

### BRIEF DESCRIPTION OF THE DRAWINGS

FIG. 1 shows a method, a vehicle, computer program, a storage medium and apparatus according to example embodiments of the present invention.

FIG. 2 shows a density function of predicted trajectories of a machine learning model according to example embodiments of the present invention.

FIG. 3 shows a density function of predicted trajectories of another machine learning model according to example embodiments of the present invention.

FIG. 4 shows a density function of predicted trajectories of another machine learning model according to example embodiments of the present invention.

### DETAILED DESCRIPTION OF EXAMPLE EMBODIMENTS

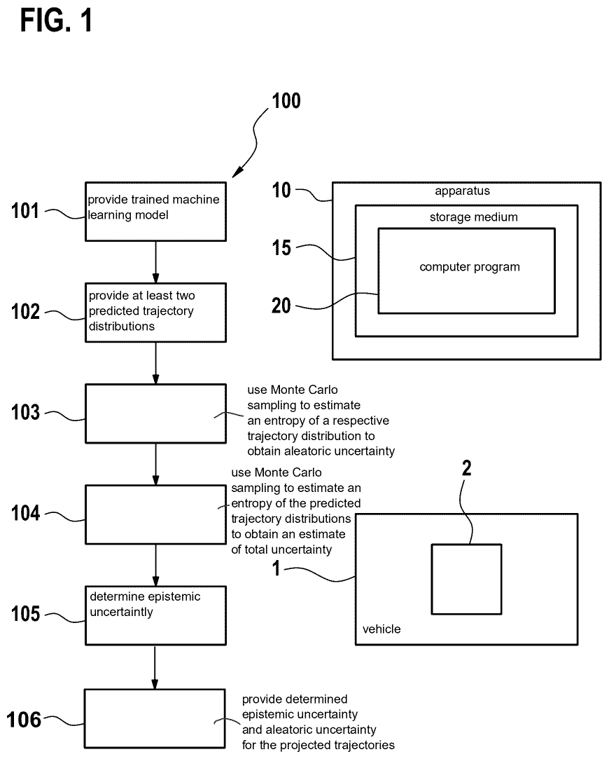

FIG. 1 shows a method 100, a vehicle 1, computer program 20, a storage medium 15 and apparatus 10 according to example embodiments of the present invention.

FIG. 1 particularly shows an embodiment of a method 100 for determining an uncertainty associated with trajectory predictions of a vehicle 1. In a first step 101, at least one trained machine learning model is provided, the at least one machine learning model being trained to predict trajectories based on sensor data and to assign scores reflecting a likelihood of each predicted trajectory. In a second step 102, at least two predicted trajectory distributions 3 are provided by means of respective predictions based on the sensor data by the at least one trained machine learning model. In a third step 103, Monte Carlo sampling is utilized to estimate an entropy of a respective predicted trajectory distribution 3, thereby obtaining an estimate of an aleatoric uncertainty. In a fourth step 104, Monte Carlo sampling is utilized to estimate an entropy of the at least two predicted trajectory distributions 3, thereby obtaining an estimate of a total uncertainty. In a fifth step 105, an epistemic uncertainty is determined by subtracting the aleatoric uncertainty from the total uncertainty. In a sixth step 106, the determined epistemic uncertainty and the aleatoric uncertainty are provided for the predicted trajectories of the at least one machine learning model.

According to the present invention, uncertainty measures for predicted trajectories are provided. This is particularly achieved by creating ensembles of state-of-the-art trajectory models, including LaPred (Kim et al., “LaPred: Lane-Aware Prediction of Multi-Modal Future Trajectories of Dynamic Agents”), LaFormer (Liu et al., “LAformer: Trajectory Prediction for Autonomous Driving with Lane-Aware Scene Constraints”), and PGP (Deo et al., “Multimodal Trajectory Prediction Conditioned on Lane-Graph Traversals”). This list shows only examples and may be extended as needed.

In contrast to methods of the related art, according to embodiments of the present invention, an estimation of a total uncertainty is considered as a decomposition of an epistemic uncertainty I(Y, Θ) (=Mutual Information) and an aleatoric uncertainty [symbol] _{q(Θ)} [H (Y|Θ, X)] (=Expected Entropy). Here, Θ, Y, x particularly represent the machine learning model parameters, predictions and inputs respectively. Since these quantities can particularly not be calculated directly, embodiments of the present invention relate to a novel approximation method.

The present invention according to embodiments comprises two key components. A utilization of an information-theoretic approach (Entropy) to measure uncertainty for trajectory prediction and a novel approximation to the Entropy terms specifically tailored for trajectory prediction.

The present invention according to embodiments provides an estimation of uncertainty measures for safety-critical applications, such as automated vehicles, which may be essential for ensuring safety. This may be achieved by creating a diverse set of viable predictions and using them to assess the required quantity. In contrast to other methods in the related art, which rely on auxiliary neural networks to approximate the prediction error, the approach according to the present invention may approximate the quantity based on the diversity of machine learning model outputs. This approach may offer the following advantages: A first advantage may regard a decomposition of uncertainty. The approach may allow for the decomposition of uncertainty into model-based and data-based uncertainty. This may enable to distinguish between uncertainty arising from novel traffic scenarios (model-based) and uncertainty arising from simply stochastic scenarios (data-based). A second advantage may regard a consideration of multiple uncertainty types. Unlike the methods in the related art, the approach according to embodiments of the present invention may consider a disagreement across different models. This may lead to more robust and accurate uncertainty quantification without requiring a separate learning phase or the tuning of an additional approximator.

The present invention may be used for analysing data obtained from a sensor. The sensor may determine measurements of the environment in the form of sensor signals, which may be given by, e.g. time series, in the form of trajectories of agents in driving scenes that may include lanes, surrounding agents, ego motion and map elements.

The present invention may be used to detect anomalies in a technical system. It does so in the following way: If the uncertainty estimated by the method is high, the input might be classified as an anomaly.

The present invention may be used to compute a control signal for controlling a technical system, like e.g. a computer-controlled machine, like a robotic system, a vehicle, a domestic appliance, a power tool, a manufacturing machine, a personal assistant or an access control system. Therefore data (e.g. scalar time series) may be analysed, especially from a sensor, namely a camera, radar, lidar and/or ultrasound sensor with a possible post processing for generating inputs for a trajectory prediction model. The technical system, particularly the vehicle, may then be operated accordingly.

The present invention may be associated with a specific physical system, namely a vehicle for autonomous driving.

Hereby the method according to embodiments of the present invention may provide a robust and more precise alternative to existing uncertainty quantification of trajectory prediction models.

The present invention may be used for selecting appropriate training data for testing, verifying and/or validating a machine learning model.

An objective of the method according to the present invention may be to offer uncertainty quantification for an automated vehicle's planning system. In safety-critical scenarios, having reliable data may be essential as the planning system may need to anticipate potential variations in the future behaviour of other road users to chart a safe route for the vehicle. However, the method according to the present invention may also be applied to enhance a trajectory prediction model used in other systems, such as active safety systems.

According to embodiments of the present invention, a future trajectory y of an agent, i.e, particularly a vehicle, may be predicted based on a past observation x, i.e, particularly sensor data. In real scenarios, there may often be multiple reasonable future trajectories, so the machine learning model according to the present invention may predict a set of K future trajectories

$$Y = {\{ {y}_{i} \}}_{i = 1}^{K}$$

and may assign each a score

$$S = {\{ {s}_{i} \}}_{i = 1}^{K}$$

representing the likelihood of the trajectory.

Additionally, uncertainty may be used as a measure of how much a machine learning model's predictions are trusted. However, the type of uncertainty to use may be unknown, as it could stem from corrupted data or the machine learning model producing unstable predictions due to the existence of multiple reasonable predictions. Therefore, the uncertainty may be decomposed into epistemic and aleatoric uncertainty.

According to embodiments of the present invention the epistemic uncertainty is computed as a difference between a total uncertainty and an aleatoric uncertainty as depicted in the following equation:

$${{\underbrace{I ( Y , θ )}}_{epistemic}}_{uncertainty} = {{{\underbrace{H [ Y \vert x ]}}_{total uncertainty}}_{quantified as the}}_{entropy} - {{\underbrace{𝔼 [ H ( Y \vert θ , x ) ]}}_{aleatoric}}_{uncertainty} . \qquad ( 1 )$$

Here, I(Y, Θ) is particularly a mutual information between the machine learning model's predictions and its parameters, and H[·] is the entropy of a probability distribution.

To estimate these quantities, i.e. uncertainties, a Monte Carlo approximation may be used. According to the present invention, at least one, particularly multiple, machine learning models such as deep neural networks, m with respective parameters

$$Θ = {\{ θ \}}_{i = 1}^{M} ,$$

may be provided, that predict an entire set of future trajectories and scores (Y and S), where Yᵢ,Sᵢ may denote the predictions of the machine learning model mᵢ.

The resulting set of predicted future trajectories may undergo a preprocessing-step to modify them before calculating the uncertainty, for example, normalizing the scores of each machine learning model as a preliminary step for sampling the trajectories. As a sampling strategy, a uniform sampling may be utilized across all members of the ensemble after normalizing the scores, or a more sophisticated method may be utilized that clusters the trajectories and then samples from those clusters.

In a general case, a set of machine learning models may be provided. According to the present invention, the uncertainty of predictions of these machine learning models may be quantified. In contrast to previous works, the uncertainty may be decomposed into epistemic and aleatoric uncertainties. First, a total uncertainty may be estimated as the entropy of the predicted trajectory distribution 3 given an input x and parameters Θ of a respective machine learning model using monte-carlo sampling:

$$\begin{matrix}I ( Y , Θ ) \approx \hat{H} [ Y \vert x ] - {𝔼}_{q ( Θ )} [ \hat{H} ( Y \vert Θ , x ) ] \\ {\overbrace{=}}^{\text{(*} )} [ - \frac{1}{N} {{\sum }_{n = 1}}^{N} log p ( {y}_{n} \vert x ) ] - {𝔼}_{q ( Θ )} [ - \frac{1}{N} {{\sum }_{n = 1}}^{N} log p ( {y}_{n} \vert θ , x ) ] \\ {\overbrace{=}}^{\text{(*} )} [ - \frac{1}{N} {{\sum }_{n = 1}}^{N} log p ( {y}_{n} \vert x ) ] - [ \frac{1}{M} {{\sum }_{m = 1}}^{M} [ - \frac{1}{N} {{\sum }_{n = 1}}^{N} log p ( {y}_{n , m} \vert {θ}_{m} , x ) ] ] \\ {{\overbrace{=}}^{of p ( y \vert x )}}^{marginalization} {\underbrace{[ - \frac{1}{N} {\sum }_{n = 1}^{N} log ( \frac{1}{M} {\sum }_{m = 1}^{M} p ( {y}_{n} \vert x , {θ}_{m} ) ) ]}}_{Total uncertainty} + {\underbrace{[ \frac{1}{MN} {\sum }_{m} [ {\sum }_{n} log p ( {y}_{n , m} \vert {θ}_{m} , x ) ] ]}}_{aleatoric uncertainty}\end{matrix} . \qquad [ 8 ]$$

$$* monte - carlo estimate of H \hat{} [ Y \vert x ] , H \hat{} ( Y \vert Θ , x )$$

Now, a Monte-Carlo estimate of the entropy may be obtained once p(y_{n,m}|x, θₘ) may be approximated, which is particularly a probability of observing the trajectory y_{n,m} that is the n-th prediction of the m-th machine learning model. There may be multiple ways of approximating this quantity. Two of them are: i) probabilistic models may predict this quantity, or ii) it may be approximated by first generating N samples y_{n,m}˜p(y_{n,m}|x, θₘ) and then fitting a distribution to it.

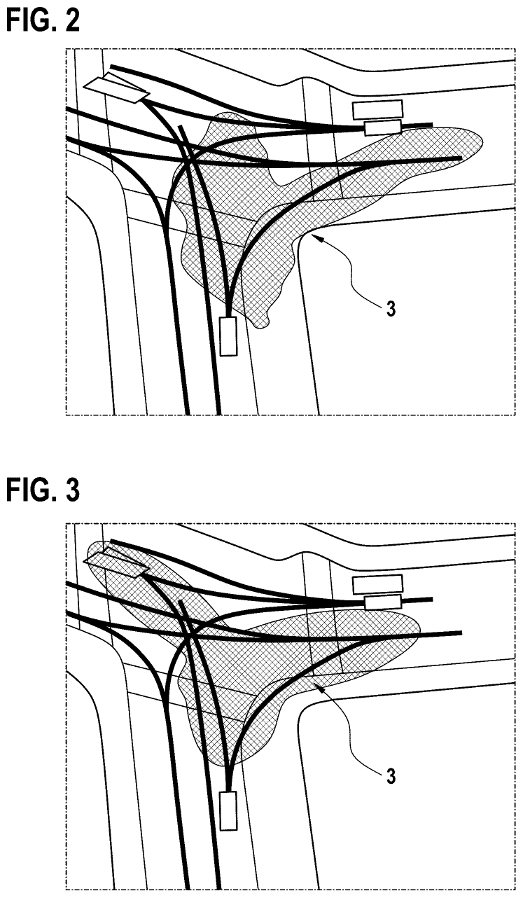

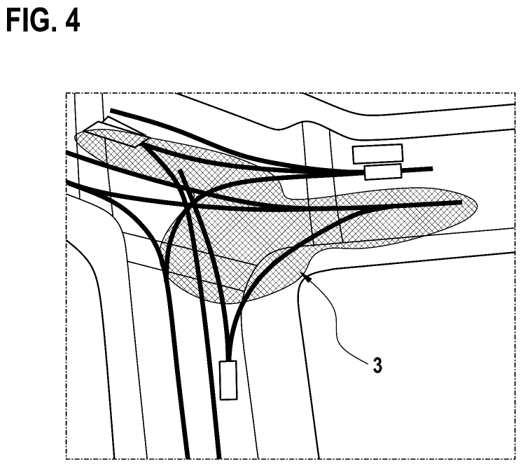

An example for the density function of p (y|x, θᵢ) for various machine learning models, i.e. the predicted trajectory distributions 3, is depicted in FIGS. 2 to 4. Each figure visualizes a distribution across multiple predictions of one respective machine learning model.

In order to assess an ability to identify errors, a correlation between a minADE₅ (an average of pointwise L2 distances between the predicted trajectory and ground truth over the k most likely predictions) and the uncertainties may be computed. A correlation between the error and uncertainty may be observed and incorporating parameter uncertainty (either through dropout or ensembling models from different families) may enhance the correlation.

The above explanation of the embodiments describes the present invention in the context of examples. Of course, individual features of the embodiments can be freely combined with each other, provided that this is technically reasonable, without leaving the scope of the present invention.

What is claimed is:

1. A method for determining an uncertainty associated with trajectory predictions of a vehicle, comprising the following steps:
providing at least one trained machine learning model, the at least one respective machine learning model being trained to predict trajectories based on sensor data and to assign scores reflecting a likelihood of each predicted trajectory;
providing at least two predicted trajectory distributions using respective predictions based on the sensor data by the at least one trained respective machine learning model;
utilizing Monte Carlo sampling to estimate an entropy of a respective predicted trajectory distribution to obtain an estimate of an aleatoric uncertainty;
utilizing Monte Carlo sampling to estimate an entropy of the at least two predicted trajectory distributions to obtain an estimate of a total uncertainty;
determining an epistemic uncertainty by subtracting the aleatoric uncertainty from the total uncertainty;
providing the determined epistemic uncertainty and the aleatoric uncertainty for the predicted trajectories of the at least one respective machine learning model.

2. The method of claim 1, wherein utilizing the Monte Carlo sampling includes:
fitting a Gaussian Mixture Model to final positions of respective predicted trajectories in the at least two predicted trajectory distributions; and
sampling from a fitted Gaussian Mixture Model of a respective predicted trajectory distribution to provide samples for estimating the aleatoric uncertainty or sampling from all fitted Gaussian Mixture Models to provide samples for estimating the total uncertainty.

3. The method of claim 1, wherein: (i) the epistemic uncertainty reflects an uncertainty due to limitations in the respective machine learning model's training or training data, and/or (ii) the aleatoric uncertainty represents an inherent randomness that the respective machine learning model cannot capture.

4. The method of claim 1, further comprising:
selecting trajectories of predicted trajectories that have an epistemic uncertainty above a defined threshold; and
providing the selected trajectories as training data for training a machine learning model based on the selected trajectories.

5. The method of claim 1, wherein a training of the at least one trained machine learning model includes:
providing training data, the training data including sensor data captured by at least one sensor and ground truth data, the ground truth data depicting trajectories that are represented in the sensor data,
extracting features from the sensor data, the extracted features including positions and/or velocities and/or objects in the sensor data, the extracted features being represented in a sequential format; and
training the at least one machine learning model based on the training data and/or the extracted features, wherein a loss function is minimized that represents a difference between trajectories predicted by the at least one machine learning model and corresponding trajectories of the ground truth data, wherein scores are assigned to each predicted trajectory reflecting a likelihood of the respective trajectory.

6. The method of claim 5, wherein at least two differently trained machine learning models are provided and the method further comprises:
determining a correlation between all of the uncertainties and an average of pointwise distances between a respective predicted trajectory and a corresponding trajectory of the ground truth data for at least two combinations of the at least two trained machine learning models.

7. The method of claim 1, further comprising:
initiating a safety measure in the vehicle based on a result of the estimate of the total uncertainty, the safety measure including: (i) an output of a warning and/or (ii) a manoeuvring of the vehicle according to a defined safety manoeuvre.

8. The method of claim 1, further comprising:
selecting a trajectory with a minimal associated uncertainty; and
initiating a manoeuvring of the vehicle along the selected trajectory.

9. A data processing apparatus configured to determine an uncertainty associated with trajectory predictions of a vehicle, the data processing apparatus configured to:
provide at least one trained machine learning model, the at least one respective machine learning model being trained to predict trajectories based on sensor data and to assign scores reflecting a likelihood of each predicted trajectory;
provide at least two predicted trajectory distributions using respective predictions based on the sensor data by the at least one trained respective machine learning model;
utilize Monte Carlo sampling to estimate an entropy of a respective predicted trajectory distribution to obtain an estimate of an aleatoric uncertainty;
utilize Monte Carlo sampling to estimate an entropy of the at least two predicted trajectory distributions to obtain an estimate of a total uncertainty;
determine an epistemic uncertainty by subtracting the aleatoric uncertainty from the total uncertainty;
provide the determined epistemic uncertainty and the aleatoric uncertainty for the predicted trajectories of the at least one respective machine learning model.

10. A non-transitory computer-readable storage medium on which is stored instructions for determining an uncertainty associated with trajectory predictions of a vehicle, the instructions, when executed by a computer, causing the computer to perform the following steps:
providing at least one trained machine learning model, the at least one respective machine learning model being trained to predict trajectories based on sensor data and to assign scores reflecting a likelihood of each predicted trajectory;
providing at least two predicted trajectory distributions using respective predictions based on the sensor data by the at least one trained respective machine learning model;
utilizing Monte Carlo sampling to estimate an entropy of a respective predicted trajectory distribution to obtain an estimate of an aleatoric uncertainty;
utilizing Monte Carlo sampling to estimate an entropy of the at least two predicted trajectory distributions to obtain an estimate of a total uncertainty;
determining an epistemic uncertainty by subtracting the aleatoric uncertainty from the total uncertainty;
providing the determined epistemic uncertainty and the aleatoric uncertainty for the predicted trajectories of the at least one respective machine learning model.
